(19) United States
(12) Patent Application Publication
(10) Pub. No.: US 2015/0178662 A1
(43) Pub. Date: Jun. 25, 2015

(54) ANALYZING AUTOMOTIVE INSPECTIONS

(71) Applicant: Scott Osborn, Rancho Palos Verdes, CA (US)

(72) Inventor: Scott Osborn, Rancho Palos Verdes, CA (US)

(21) Appl. No.: 14/289,039

(22) Filed: May 28, 2014

(51) Int. Cl. G06Q 10/06; G06Q 10/00; G06Q 30/06; G01M 17/007

(52) U.S. Cl. CPC G06Q 10/06398; G01M 17/007; G06Q 10/20; G06Q 30/0631

(57) ABSTRACT

For analyzing automotive inspections, a recording module records a plurality of inspection results. Each inspection result comprises a technician identifier and an inspection item recommendation for each of a plurality of inspection items. Each inspection item comprises a target recommendation. The inspection item recommendation comprises one of a no service required recommendation and a service recommendation. An identification module identifies a recommendation bias in response to a function of first inspection item recommendations for a first inspection item of the plurality of inspection results exceeding a first target recommendation for the first inspection item.

### FIELD

The subject matter disclosed herein relates to automotive inspections and more particularly relates to analyzing automotive inspections.

### BACKGROUND

### Description of the Related Art

Automotive inspections are designed to discover service needs for an automobile. However, technician biases may result in some service needs not being discovered while other service needs are reported as required when there is no need for the service.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an automotive inspection analysis system;

FIG. 2A is a schematic block diagram illustrating one embodiment of an inspection results database;

FIG. 2B is a schematic block diagram illustrating one embodiment of an inspection result;

FIG. 2C is a schematic block diagram illustrating one embodiment of an inspection item recommendation;

FIG. 2D is a schematic block diagram illustrating one embodiment of an inspection item database;

FIG. 2E is a schematic block diagram illustrating one embodiment of an inspection item;

FIG. 3A is a schematic block diagram illustrating one embodiment of a computer;

FIG. 3B is a schematic block diagram illustrating one embodiment of an analysis apparatus;

FIG. 4A is a drawing illustrating one embodiment of inspection input;

FIG. 4B is a drawing illustrating one embodiment of analysis selection;

FIG. 4C is a drawing illustrating one embodiment of sales input;

FIG. 4D is a drawing illustrating one embodiment of an inspection bias report;

FIG. 4E is a text illustration showing one embodiment of an inspection bias report entry;

FIG. 5A is a schematic flow chart diagram illustrating one embodiment of an automotive inspection analysis method;

FIG. 5B is a schematic flow chart diagram illustrating one embodiment of an inspection bias identification method;

FIG. 5C is a schematic flow chart diagram illustrating one embodiment of an assignment bias identification method; and

FIG. 5D is a schematic flow chart diagram illustrating one embodiment of a sales bias identification method.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible, non-transitory computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

Computer readable program code for carrying out operations for aspects of the present invention may be written in any combination of one or more programming languages, including an object oriented programming language such as Python, Rudy, Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

The description of elements in each figure may refer to elements of proceeding figures. Like numbers refer to like elements in all figures, including alternate embodiments of like elements.

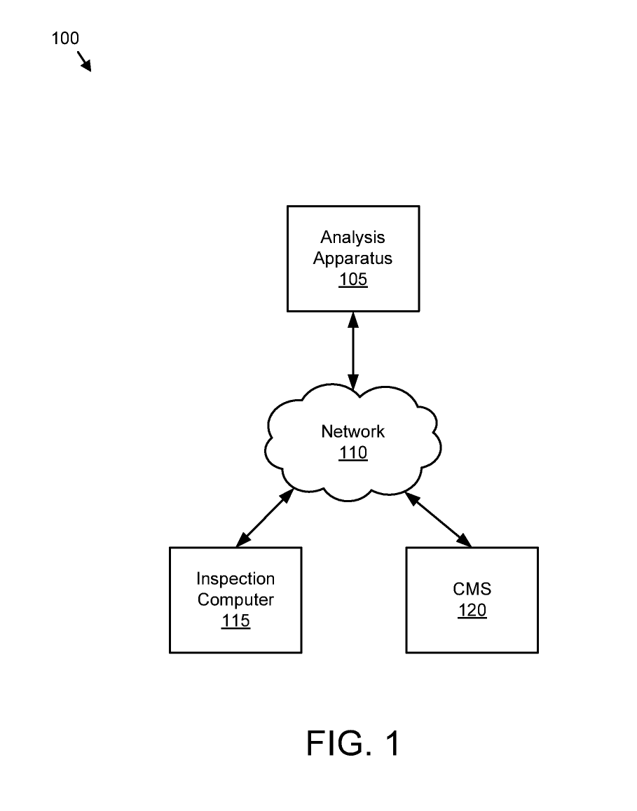

FIG. 1 is a schematic block diagram illustrating one embodiment of an automotive inspection analysis system 100. The system 100 includes an analysis apparatus 105, a network 110, an inspection computer 115, and a customer management system 120. The analysis apparatus 105 may be embodied in a computer such as a server, server farm, a main frame computer, and the like.

The network 110 may be the Internet, a local area network, a wide-area network, a local area network, a mobile telephone network, a Wi-Fi network, and the like. The inspection computer 115 may be a portable computer such as a tablet computer and/or a laptop computer. Alternatively, the inspection computer 115 may be a mobile telephone, a computer workstation, a wearable computer, and the like.

The customer management system 120 may be embodied in a computer, a server, server farm, a mainframe computer, and the like. The customer management system 120 may store auto information such as a customer name, a customer address, a license plate number, a vehicle identification number, an auto year, an auto make, an auto model, an auto service record, reporting data, and the like. The reporting data may indicate a destination for inspection results such as a state motor vehicle authority. In one embodiment, the analysis apparatus 105 is also embodied in the server, server farm, and/or mainframe computer.

A technician may employ the inspection computer 115 while inspecting an automobile. When inspecting the automobile, the technician may retrieve customer information from the customer management system 120. In one embodiment, the technician retrieves the auto information from the inspection computer 115 through the network 110. Alternatively, the technician retrieves the auto information directly from the customer management system 120.

The technician may further inspect the automobile and record the results of the inspection as inspection results as will be described hereafter. In one embodiment, the technician records the inspection results directly to the inspection computer 115 and the inspection results are communicated to the analysis apparatus 105. In an alternative embodiment, the technician records the inspection results on a paper copy and enters the inspection results at the inspection computer 115.

The technician may be prone to under identify some service needs. For example, if the technician is inexperienced, he may regularly overlook one type of service need. In addition, the technician may not identify service needs that he does not like to correct and/or is uncertain how to correct. As a result, service needs may go unidentified and unaddressed. Alternatively, a technician may be prone to identify service needs where there is none. For example, if the technician enjoys performing a service function and/or can complete the service function quickly, the technician may be prone to identify such a service need when there is no actual need. As a result, a customer may pay for unneeded service functions, resulting in ill will towards the technician and his employer.

The embodiments described herein analyze automotive inspections and identify a recommendation bias as will be described hereafter. The recommendation bias can be used to correct technician behavior, to identify training needs, identify misbehavior, and to generally improve the effectiveness of the automotive inspections.

A manager may distribute service tasks among one or more technicians. The manager may distribute the service tasks based on personal relationships rather than the skills of the technicians. As a result, some technicians may regularly perform service tasks for which they are unqualified while the talents of other technicians are underutilized. The embodiments described herein also identify assignment bias in assigning service tasks to technicians as will be described hereafter. As a result, the manager may be trained to better utilize the skills of the technicians.

The technician and/or manager may recommend one or more service tasks to the customer after making the inspection. The technician and/or manager may be inclined to oversell and/or undersell some service tasks because of personal preferences, personal opinions, or the like. The embodiments described herein also identify sales bias so that the manager and/or technician may be trained to emphasize the service tasks that are of most use to the customer.

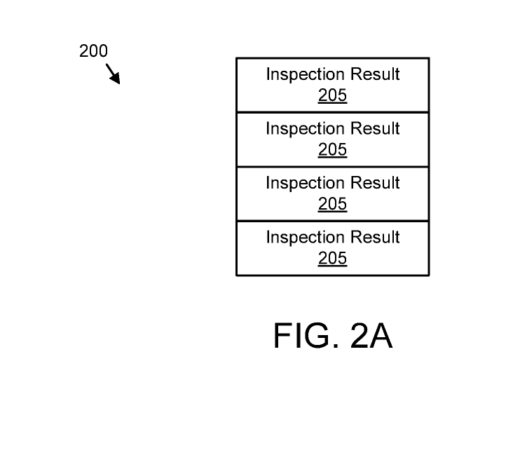

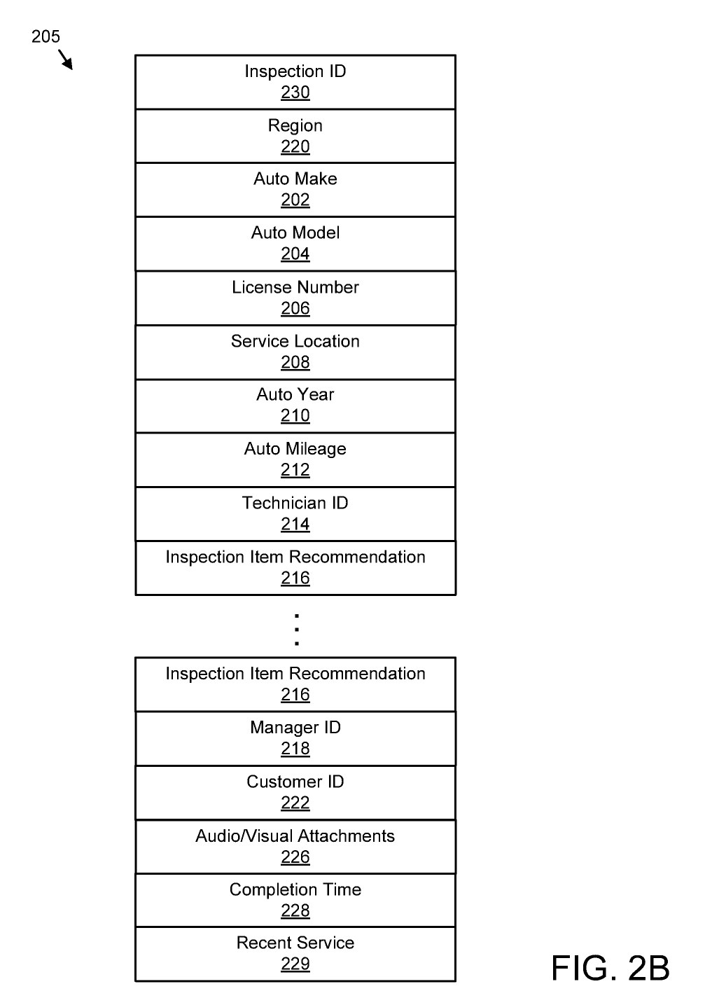

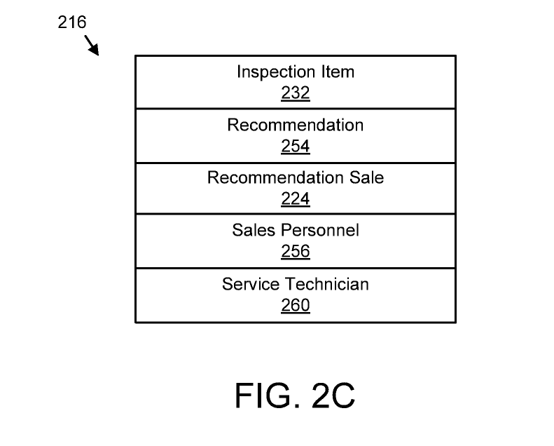

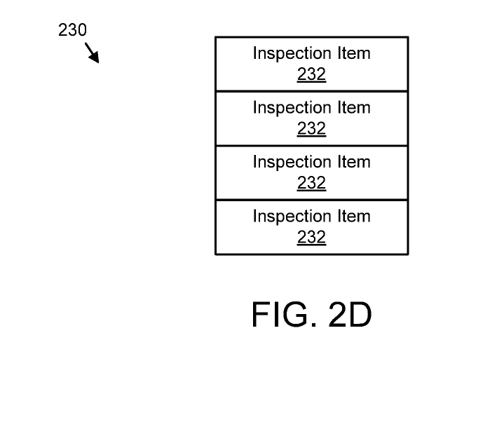

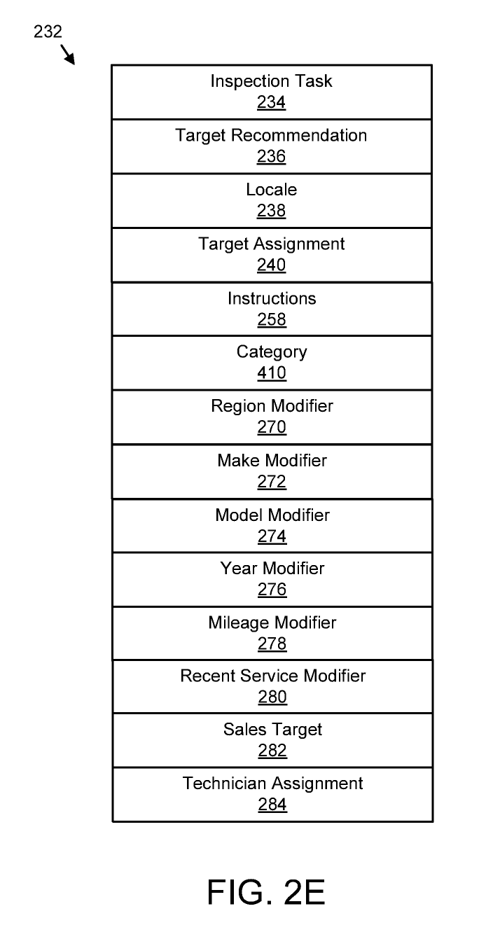

FIG. 2A is a schematic block diagram illustrating one embodiment of an inspection results database 200. The inspection results database 200 may be stored in the analysis apparatus 105. The inspection results database 200 maybe organized as one or more tables, one or more data structures, one or more flat files, or combinations thereof. The inspection results database 200 includes a plurality of inspection results 205. Each inspection result 205 may be generated from the inspection of an automobile. In one embodiment, each inspection instance for a specified automobile generates a new inspection result 205.

FIG. 2B is a schematic block diagram illustrating one embodiment of an inspection result 205 of the inspection results database 200 of FIG. 2. The inspection result 205 may be organized as one or more tables, one or more data structures, one or more flat files, or combinations thereof. In the depicted embodiment, each inspection result 205 includes an inspection identifier 230, a region 220, an auto make 202, an auto model 204, a license number 206, a service location 208, an auto year 210, an auto mileage 212a technician identifier 214, one or more inspection item recommendations 216, a manager identifier 218, a customer identifier 222, audio/visual attachments 226, a completion time 228, and recent service 229.

The inspection identifier 230 may specify a one or more inspections that were performed on the automobile. Each inspection may be associated with one or more inspection items as will be described hereafter. For example, the inspection identifier 230 may specify a multi-point inspection, a comprehensive inspection, a diagnostic flowsheet inspection, and air-conditioning inspection, a break inspection, a battery inspection, a shop inspection, or the like.

The region 220 may describe a geographic region. Alternatively, the region 220 describes a climactic region. The auto make 202 may describe the make of the automobile being inspected. The auto model 204 may describe the model of the automobile. The license number 206 may be the license number of the automobile. In addition, the license number 206 may include a vehicle identification number (VIN) or the like. The service location 208 may identify the facility where the inspection is performed, or the facility where the technician is based. The service location 208 may also identify an operator of the service location.

The auto year 210 may be the model year of the automobile. The auto make 202, auto model 204, license number 206, and auto year 210 may be retrieved from the customer management system 120. The auto mileage 212 may be recorded by the technician during the inspection.

The technician identifier 214 may uniquely identify the technician. The technician identifier 214 may be an employee number, a biometric, or combinations thereof. The technician identifier 214 may include the technician's name, an image of the technician, contact information for the technician, or combinations thereof.

Each inspection item recommendation 216 is linked to a corresponding an inspection item 232 for an inspection 230 as will be described hereafter. For example, an inspection item 232 may be “inspect brake pad wear.” The inspection item recommendation 216 is described in greater detail in FIG. 2C.

The manager identifier 218 may identify the manager supervising the technician that is inspecting the automobile. The customer identifier 222 may uniquely identify the customer of the automobile inspection. The customer identifier 222 may be a customer name and contact information. In one embodiment, the customer identifier 222 references the customer information from the customer management system 120.

The audio/visual attachments 226 may include image files, audio files, and/or video files recorded during the inspection and/or related to the inspection. For example, the technician may record images, audio commentary, and/or video commentary showing elements of the inspection.

The completion time 228 may record the time interval required for the technician to complete the inspection of the automobile. In one embodiment, the completion time 228 includes a start time and an end time. The recent service 229 may record service of the automobile has recently received. For example, the recent service 229 may record the changing of wiper blades along with the date of the service.

FIG. 2C is a schematic block diagram illustrating one embodiment of an inspection item recommendation 216. The inspection item recommendation 216 may be organized as a table entry, a data structure, a flat file, or combinations thereof. The inspection item recommendation 216 is the inspection item recommendation 216 of FIG. 2B. In the depicted embodiment, the inspection item recommendation 216 includes an inspection item 232, a recommendation 254, a recommendation sale 224, a sales personnel 256, and a service technician.

The inspection item 232 identifies inspection item from an inspection item database. The inspection item 232 may provide parameters, instructions, and the like for the inspection item recommendation 216. The recommendation 254 may comprise one of a no service required recommendation and a service recommendation. The no service required recommendation indicates that no service is needed now. The service recommendation indicates that service is needed now and/or soon. In one embodiment, the recommendation 254 includes a warning recommendation. The warning recommendation may indicate that service is needed in the near future. For example, the warning recommendation may indicate that service will likely be needed in the next 2 months.

For example, if the technician determines that there is no service need with regards to the brake pad wear, the technician records a no service required recommendation for the recommendation 254. However if the technician determines that there is a service need, the technician records a service recommendation for the inspection in the recommendation 254.

In one embodiment, the service recommendation and/or warning recommendation may specify a service task. For example, the service recommendation may include the service task “replace brake pads.”

The recommendation sale 224 indicates if each service recommendation was sold and performed. In one embodiment, the recommendation sale 224 includes a binary value indicating whether or not the service recommendation was sold and performed. Alternatively, the recommendation sale 224 comprises a price for services performed in response to the service recommendation.

The sales personnel 256 may record the person selling the service recommendation to the customer. The sales personnel 256 may be the technician that performed the inspection, another technician, and/or a manager. The service technician 260 records the technician performing the service.

FIG. 2D is a schematic block diagram illustrating one embodiment of an inspection item database 230. The inspection item database 230 may reside in the analysis apparatus 105. The inspection item database 230 may be organized as one or more tables, one or more data structures, one or more flat files, or combinations thereof. The inspection item database 230 includes a plurality of inspection items 232. The inspection items 232 may be entered by an administrator.

FIG. 2E is a schematic block diagram illustrating one embodiment of the inspection item 232 of the inspection item database 230 of FIG. 2D. Each inspection item 232 may include an inspection task 234, a target recommendation 236. In addition, each inspection item 232 may include a locale 238, a target assignment 240, instructions 258, a category 410, a region modifier 270, a make modifier 272, a model modifier 274, a year modifier 276, a mileage modifier 278, a recent service modifier 280, a sales target 282, and a technician assignment 284.

The inspection task 234 may identify the inspection action to be performed. In a certain embodiment, the inspection task 234 further specifies an inspection action for an auto year 210 and/or auto mileage 212. For example, the auto year 210 may specify that the inspection item 232 is to be performed for automobiles with an auto year 210 of 2013. Thus the inspection item 232 may be specific to the auto year 210 and/or to the auto mileage 212. In an alternate embodiment, the inspection task 234 may specify an auto make 202, an auto model 204, a region 220, a service location 208, a technician, an operator, and the like. The instructions 258 may describe the procedure for performing the inspection. In addition, the instructions 258 may include sales instructions.

The target recommendation 236 may specify a percentage of automobiles that are statistically likely to have a service need for the inspection item 232. In one embodiment, the target recommendation 236 specifies a percentage of automobiles that are likely to have the service need based on the auto make 202, the auto model 204, the region 220, the auto year 210, the auto mileage 212 and/or recent service 229 that the automobile has received. Alternatively, the target recommendation 236 may be modified based on the auto make 202, the auto model 204, the region 220, the auto year 210, the auto mileage 212, and/or recent service 229 using the region modifier 270, make modifier 272, model modifier 274, year modifier 276, mileage modifier 278, and recent service modifier 280. In one embodiment, the target recommendation includes a target recommendation upper bound and a target recommendation lower bound.

A function of the inspection item recommendations 216 for a first inspection item 232 that exceed the target recommendation 236 by either being recommended more frequently or less frequently than the target recommendation 236, or the target recommendation upper bound and target recommendation lower bound may identify a recommendation bias as will be described hereafter. In one embodiment, the target recommendation 236 includes a guard band. The guard band may specify an acceptable percentage for the function of the inspection item recommendations 216 above the target recommendation 236 or the target recommendation upper bound and an acceptable percentage for the function of the inspection item recommendations 216 below the target recommendation 236 of the target recommendation lower bound. The guard band may be adjusted for each technician, manager, service location, and/or region based on a number of similar inspections performed by the technician, manager, service location, and/or region. For example, if the technician performs a small number of similar inspections, the guard band may be large. However, if the technician performs a large number of similar inspections, the guard band may be small.

For example, the target recommendation 236 may be 10 percent. The guard band may further specify that an additional 5 percent above the target recommendation 236 and/or an additional 3 percent below the target recommendation 236. The function of the inspection item recommendations 216 that exceed the guard band of the target recommendation 236 may identify the recommendation bias.

The locale 238 may indicate where the inspection item 232 is to be used. For example, the locale 238 may indicate one or more states, one or more cities, one or more shop locations, and the like. The locale 238 may distinguish inspection items that only apply in selected jurisdictions.

In one embodiment, the target assignment 240 indicates a target for assignments of service recommendations to technicians. The target assignment 240 may specify required levels of training and experience for a technician to be assigned to service task resulting from a service recommendation for the inspection item 232 In one embodiment, the target assignment 240 may indicate that each technician with the required levels of training and experience within a service location be equally likely to be assigned a service task. In an alternative embodiment, the target assignment 240 may specify that technicians with more experience be more likely to be assigned to the service task.

Alternatively, the target assignment 240 may be set by the administrator. The target assignment 240 may be used to determine assignment bias as will be described hereafter. The category 410 may assign the inspection item 232 to a specified category of related inspection items 232.

The sales target 282 may be a percentage of recommendations 254 that are service recommendations that typically should be converted into recommendation sales 224. In one embodiment, the sales target 282 specifies a percentage of service recommendations that typically should be converted into recommendation sales 224 based on the auto make 202, the auto model 204, the region 220, the auto year 210, the auto mileage 212 and/or recent service 229 that the automobile has received.

The region modifier 270, make modifier 272, model modifier 274, year modifier 276, mileage modifier 278, and recent service modifier 280 may store values that are used to modify the target recommendation 236 and/or target sales 282 in response to the region 220, the auto make 202, the auto model 204, the auto year 210, the auto mileage 212, and recent service 229 respectively. The region modifier 270, make modifier 272, model modifier 274, year modifier 276, mileage modifier 278, and recent service modifier 280 may be set by the administrator or calculated from inspection data. For example, if the target recommendation 236 does not specify a percentage of automobiles that are statistically likely to have a service need for the inspection item 232 based on the auto make 202, the auto model 204, the region 220, the auto year 210, the auto mileage 212 and/or recent service of the automobile being inspected, the region modifier 270, make modifier 272, model modifier 274, year modifier 276, mileage modifier 278, and recent service modifier 280 may be used to modify the target recommendation 236 to more closely reflect the service needs of the automobile being inspected.

The technician assignment 284 may indicate the technician that was assigned to perform the service task in response to the service recommendation. The technician assignment 284 may be different from the technician that performed the inspection recorded by the technician identifier 214.

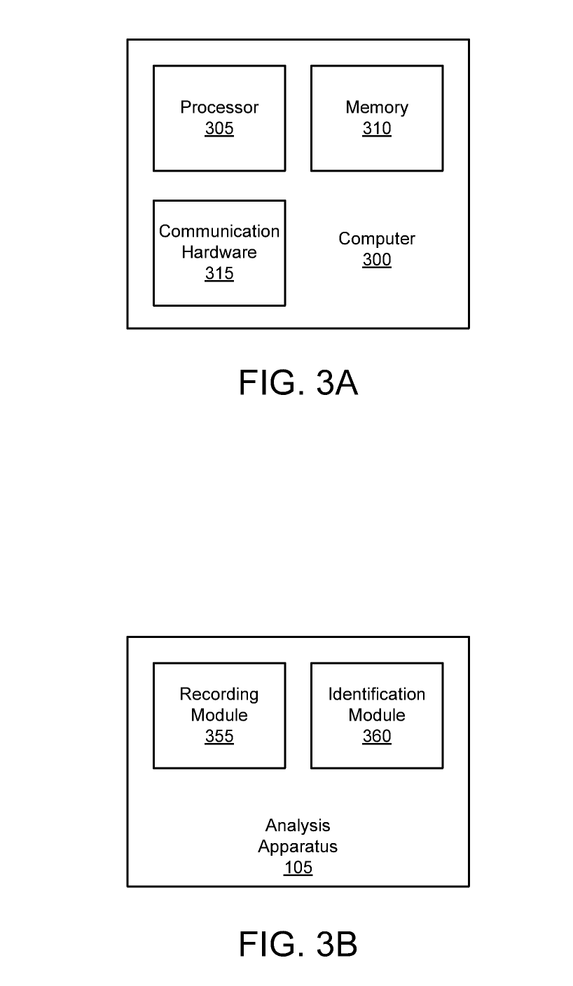

FIG. 3A is a schematic block diagram illustrating one embodiment of a computer 300. The computer 300 may be representative of the inspection computer 115. In addition, the analysis apparatus 105 and/or the customer management system 120 may be embodied in one or more computers 300. The computer 300 includes a processor 305, a memory 310, and communication hardware 315. The memory 310 may comprise a semiconductor storage device, hard disk drive, an optical storage device, a micromechanical storage device, or combinations thereof. The memory 310 may store program code. The processor 305 may execute the program code. The communication hardware 315 may communicate with other devices.

FIG. 3B is a schematic block diagram illustrating one embodiment of an analysis apparatus 105. The apparatus 105 may be embodied in the computer 300. In a certain embodiment, the apparatus 105 is embodied in the inspection computer 115, the customer management system 120, or combinations thereof. The apparatus 105 includes a recording module 355 and an identification module 360. The recording module 355 and the identification module 360 may be embodied in a computer readable storage medium such as the memory 310. The computer readable storage media may store program code that is executed by the processor 305 to perform the functions of the recording module 355 and the identification module 360.

In one embodiment, the recording module 355 records a plurality of inspection results 205. The identification module 360 may identify a recommendation bias in response to a function of first inspection item recommendations 216 for a first inspection item 232 of the plurality of inspection results 205 exceeding a first target recommendation 236 for the first inspection item 232 as will be described hereafter.

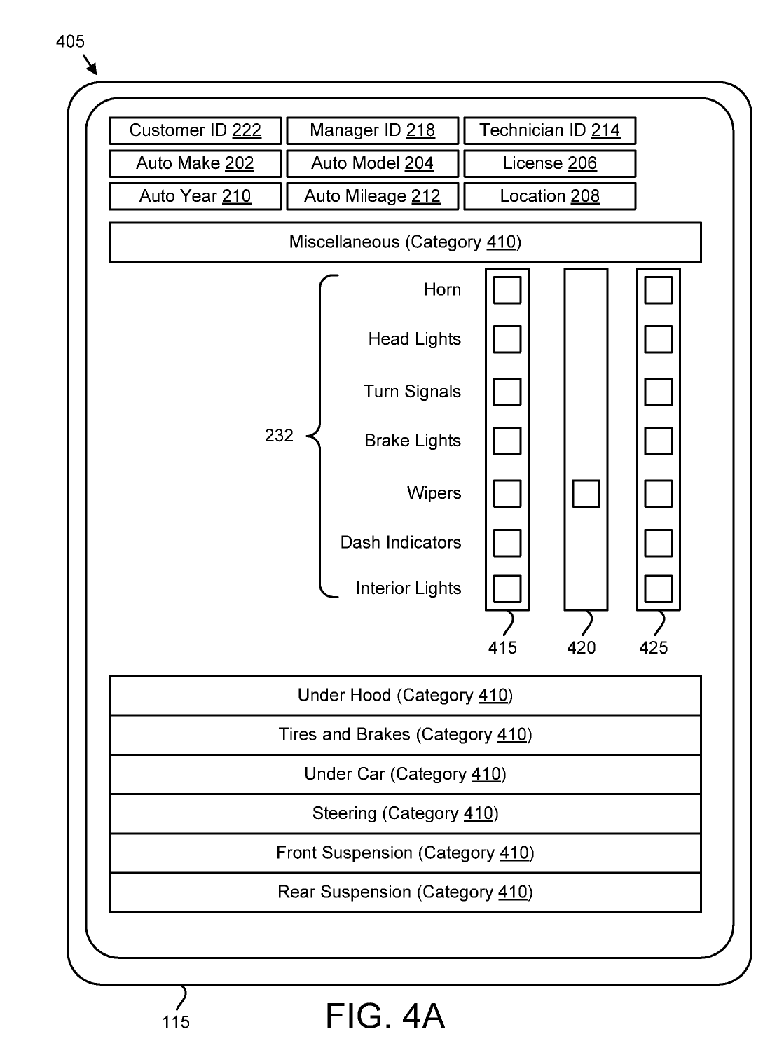

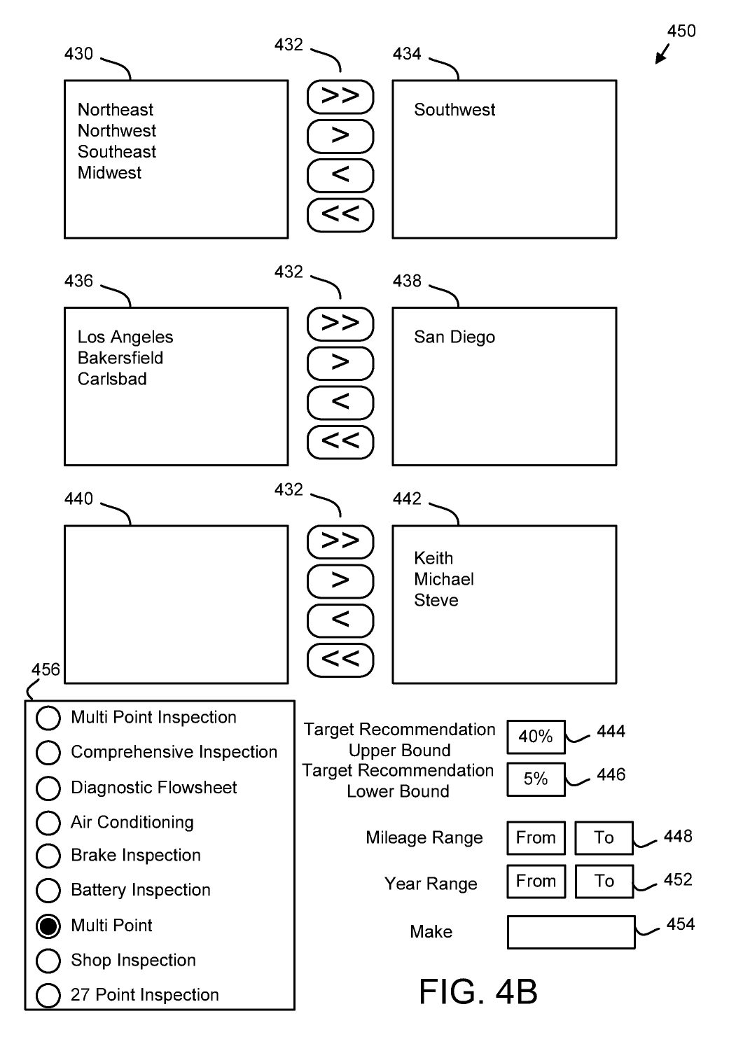

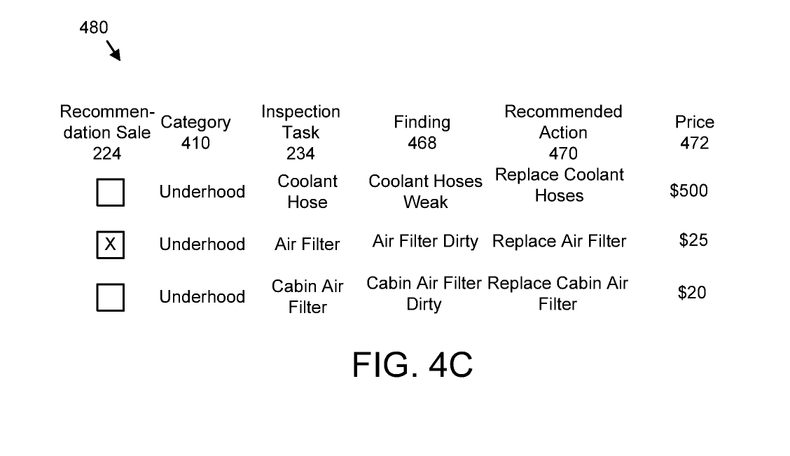

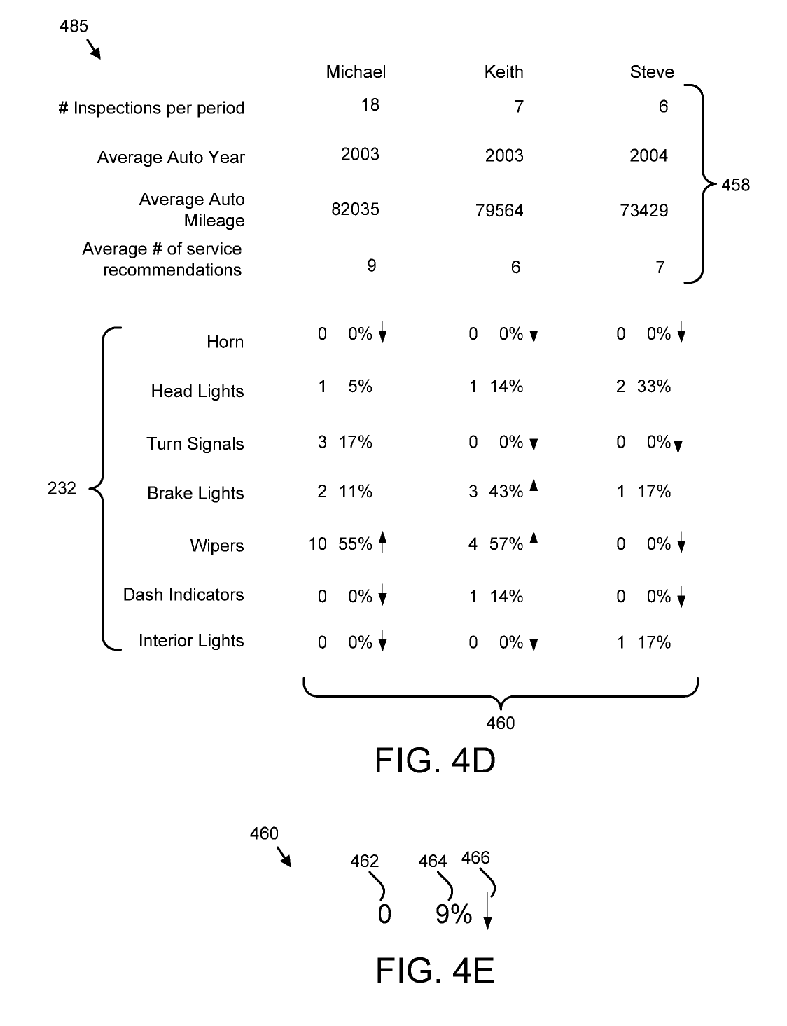

FIG. 4A is a drawing illustrating one embodiment of inspection input 405. In the depicted embodiment, the inspection input 405 is received on a tablet computer inspection computer 115. The technician may input information to the inspection computer 115. In addition, information may be retrieved from the customer management system 120.

In the depicted embodiment, the inspection input 405 includes the customer identifier 222, the manager identifier 218, the technician identifier 214, the auto make 202, the auto model 204, the license number 206, the auto year 210, the auto mileage 212, and the service location 208. In addition, the inspection input 405 may include one or more categories 410. In the depicted embodiment, miscellaneous, under hood, tires and brakes, under car, steering, front suspension, and rear suspension categories 410 are shown. The technician may select a category 410 to display inspection items 232 associated with the category 410. In the depicted embodiment, the miscellaneous category 410 is selected.

During an inspection, the technician may perform the inspection for each inspection item 232 and select one of a no service required recommendation 415, a warning recommendation 420, or a service recommendation 425 that will be recorded as the recommendation 254. The warning recommendation 420 may not be available for all inspection items 232.

FIG. 4B is a drawing illustrating one embodiment of analysis selection 450. The analysis selection 450 may be an interface on a computer 300 that is used to analyze the results of inspections for inspection bias, assignment bias, and/or sales bias. In the depicted embodiment, the user is presented with a region list 430, a service location list 436, and a technician list 440. The user may employ selection controls 432 to choose selected regions 434, selected service locations 438, and/or selected technicians 442. The inspection results will be analyzed for the selected regions 434, selected service locations 438, and/or selected technicians 442.

In addition, the user may select one or more inspection identifiers 230 from an inspection list 456. In one embodiment, only inspection results for the selected inspection identifiers 230 may be analyzed. In addition, the user may select a mileage range 448, a year range 452, and/or a make 454. The mileage range 448, year range 452, and make 454 may be used to select specified auto years 210, auto mileages 212, and auto makes 202 for analysis.

In one embodiment, the user selects a target recommendation upper bound 444. In addition, the user may select a target recommendation lower bound 446. The target recommendation upper bound 444 and target recommendation lower bound 446 may be used to identify inspection bias as will be described hereafter.

FIG. 4C is a drawing illustrating one embodiment of sales input 480. The sales input 480 may be an interface on the computer 300 and/or inspection computer 115. A user such as the technician and/or manager may use the sales input 480 to indicate whether service recommendations 415 were purchased by the customer. In the depicted embodiment, the sales input 480 lists the category 410, the inspection task 234, a finding 468, a recommended action 470, and a price 472 for each sales recommendation. The user may further indicate if a recommendation sale 224 occurred, such as by checking a box.

FIG. 4D is a drawing illustrating one embodiment of an inspection bias report 485. The inspection bias report 485 may be generated by the analysis apparatus 105 to show inspection bias. In the depicted embodiment, the report 485 includes sample information 458 for one or more technicians. The sample information 458 includes a number of inspections per period, an average auto year for the automobiles inspected, an average auto mileage for the automobiles inspected, and an average number of service recommendations 415 by the technician.

Inspection bias report 485 may further include a plurality of inspection items 232 with inspection bias report entries 460 for each inspection item 232 as will be described hereafter in FIG. 4E.

FIG. 4E is a text illustration showing one embodiment of an inspection bias report entry 460. In the depicted embodiment, the inspection bias report entry 460 includes a number of service recommendations 462 by a technician, a service recommendation percentage 464 for the technician, and a bias indicator 466.

The number of service recommendations 462 may indicate a number of times the technician made a service recommendation 415 for the inspection item 432 within the sample of inspections. The service recommendation percentage 464 is a percentage of service recommendations 415 for the inspection item 432 within the sample of inspections.

The bias indicator 466 may indicate that the service recommendation percentage 464 exceeds either the target recommendation upper bound 444 and/or the target recommendation lower bound 446. In one embodiment, the bias indicator 466 indicates that the service recommendation percentage 464 exceeds the target recommendation upper bound 444 plus a guard band or the target recommendation lower bound 446 plus the guard band. In the depicted embodiment, the bias indicator 466 is an arrow that may point down if the service recommendation percentage 464 exceeds the target recommendation lower bound 446 and point up if the service recommendation percentage 464 exceeds the target recommendation upper bound 444.

Alternatively, the bias indicator 466 may be a color. For example, the bias indicator 466 may be a green color if the service recommendation percentage 464 exceeds the target recommendation upper bound 444 and a red color if the service recommendation percentage 464 exceeds the target recommendation lower bound 446.

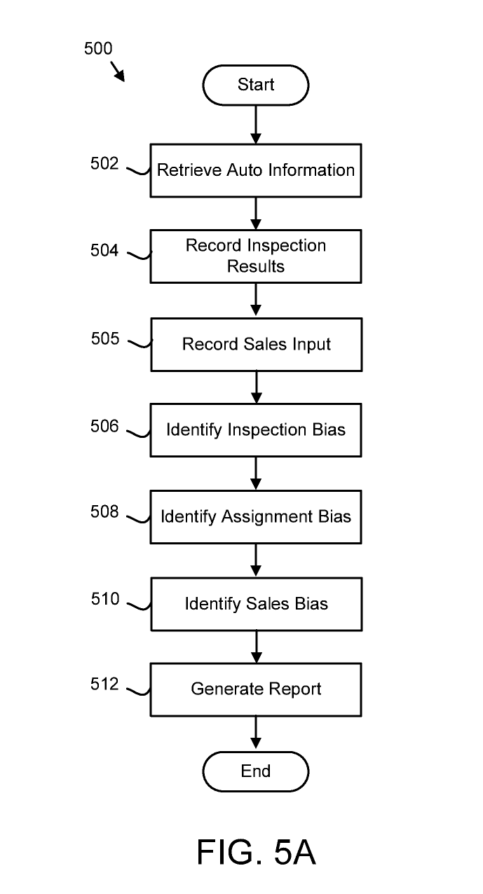

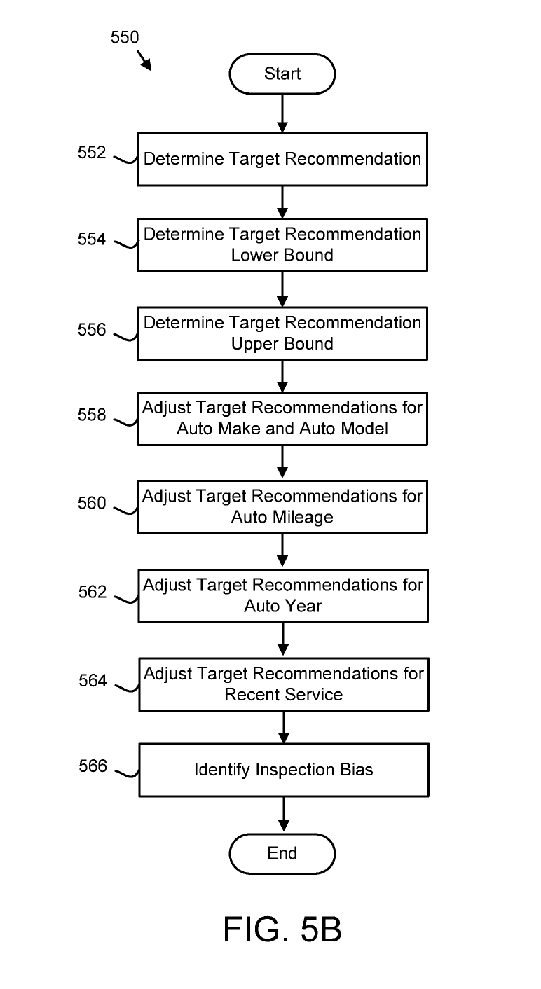

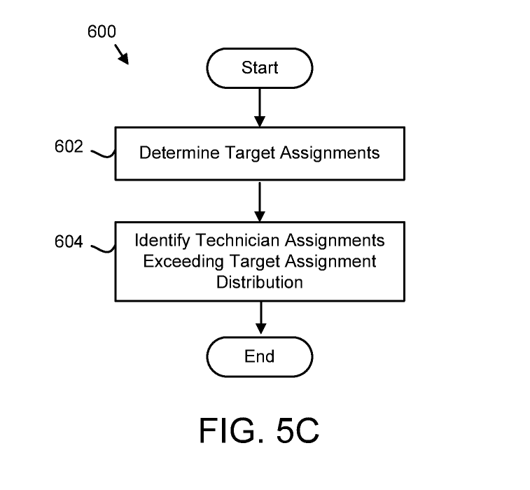

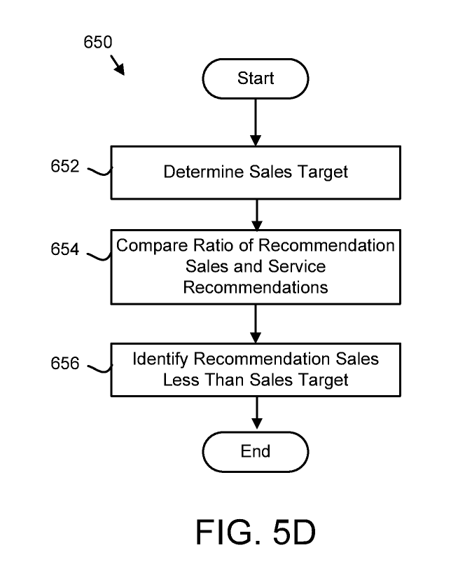

FIG. 5A is a schematic flow chart diagram illustrating one embodiment of an automotive inspection analysis method 500. The method 500 may identify inspection bias. In addition, the method 500 may identify assignment bias and/or sales bias. The method 500 may be performed by a processor 305. In one embodiment, the method 500 is performed by program code stored on a computer readable storage medium such as the memory 310 and executed by a processor 305 to perform the functions of the method 500.

The method 500 starts, and in one embodiment, the recording module 355 retrieves 502 the auto information from the customer management system 120. For example, technician may enter the license number at the inspection computer 115 and retrieve 500 to the auto information.

The recording module 355 may further record 504 one or more inspection results 205 from an auto inspection. In one embodiment, a technician records 504 the inspection result 205 directly to the inspection input 405 on the inspection computer 115 and the inspection computer 115 communicates the inspection result 205 to the analysis apparatus 105. Alternatively, the technician may copy the inspection results from a paper copy to the inspection computer 115 and the inspection computer 115 communicates the inspection result 205 to the analysis apparatus 105.

The recording module 355 may further record 505 sales input 480. The sales input 480 may be entered to a computer 300 such as the inspection computer 115. Alternatively, the sales input 480 may be transferred to the computer 300.

The identification module 360 may identify 506 an inspection bias. The identification module 360 may identify the inspection bias in response to a function of first inspection item recommendations 216 for a first inspection item 232 of the plurality of inspection results 205 exceeding a first target recommendation 236 for the first inspection item 232. Identifying 506 the inspection bias is described in more detail in FIG. 5B.

The identification module 360 may further identify 508 assignment bias. The analysis apparatus 105 may identify 508 the assignment bias if a function of technician assignments 284 for the first inspection item 232 of the plurality of inspection results 205 exceeds a first target assignment 240 for the first inspection item 232. Identifying 508 the assignment bias is described in more detail in FIG. 5C.

The identification module 360 may identify 510 a sales bias. In one embodiment, the sales bias is identified 510 in response to a ratio of the recommendation sales 224 to the service recommendations 415 being less than the sales target 282. Identifying 510 the sales bias is described in more detail in FIG. 5D.

The analysis apparatus 105 may generate 512 a report and the method 500 ends. The report may include identified inspection biases, identified assignment biases, identified sales biases, and the comparison of service recommendations and recommendation sales 224. In one embodiment, the report includes the inspection bias report 485. The report may be used to correct inspection and assignment practices, as well as improve the sale of services.

FIG. 5B is a schematic flow chart diagram illustrating one embodiment of an inspection bias identification method 550. The method 550 may be performed by a processor 305. In one embodiment, the method 550 is performed by program code stored on a computer readable storage medium such as the memory 310 and executed by a processor 305 to perform the functions of the method 550.

The method 550 starts, and in one embodiment, the recording module 355 determines 552 target recommendations 236. The recording module 355 may determine 552 the target recommendations 236 for each inspection item 232. In one embodiment, an administrator enters the target recommendations 236 using the analysis selection 450. For example, the administrator may set a target recommendation upper bound 444 and a target recommendation lower bound 446.

In one embodiment, the recording module 355 determines 552 the target recommendations 236 from stored data. For example, the target recommendations 236 may be calculated from all past recommendations 254 for each inspection item 232. In one embodiment, the target recommendations 236 are calculated based on the region 220, auto make 202, auto model 204, auto year 210, and/or auto mileage 212. For example, the target recommendation 236 for automatic transmission fluid may be a function of the auto mileage 212 and recent service 229.

In one embodiment, the target recommendation 236 TR may be calculated using equation 1, where B is a base target recommendation that is entered by the administrator, K and E are non-zero constants, J and F are constants, AY is years since the auto year 210 and AM is the auto mileage 212.

TR=B+(K*AŶJ)+(E*AM̂F) Equation 1

In an alternative embodiment, the target recommendation 236 is calculated as a function of the auto year 210 and the auto mileage 212. For example, the target recommendation 236 TR may be calculated using equation 2.

TR=(K*AŶJ)+(E*AM̂F) Equation 2

In one embodiment, the target recommendation 236 is a function of the inspection item recommendations 216 for one or more technicians, one or more service locations, and/or one or more regions. The function of the inspection item recommendations 216 may be selected from the group consisting of an arithmetic mean, a geometric mean, a harmonic mean, a quadratic mean, a generalized mean, a weighted mean, a truncated mean, an interquartile mean, a midrange, a Winsorized mean, a mode, and a median. For example, the function of the inspection item recommendations 216 may be the median of all inspection item recommendations 216 for an inspection item 232.

Alternatively, the target recommendation 236 for inspection item 232 may be calculated as an arithmetic mean of all inspection item recommendations 216 for the inspection item 232 for all technicians in a specified region. In one embodiment, the target recommendation 236 may be calculated as a midrange of the inspection item recommendations 216 for a specified region 220.

In one embodiment, the target recommendations 236 are based on the recent service 229 and/or the recent service modifier 280. For example, the target recommendation 236 for wiper blades may be a function of a changed wiper blades recent service 229 and the recent service modifier 280. The recent service modifier 280 may indicate that wiper blades should be changed as early as 6 months and no later than 12 months after the wiper blades were last changed during recent service 229.

The recording module 355 may further determine 554 the target recommendation lower bound 446 and determine 556 the target recommendation upper bound 444. In one embodiment, both the target recommendation lower bound 446 and the target recommendation upper bound 440 for are input by the administrator. Alternatively, the target recommendation lower bound 446 and the target recommendation upper bound 444 may be calculated from the target recommendation 236.

In one embodiment, a Gaussian distribution is calculated for the target recommendations 236. The target recommendation upper bound 444 and the target recommendation lower bound 446 may each be set at a specified number of standard deviations from the mean of the Gaussian distribution. The specified number of standard deviations may be set by the administrator.

In an alternative embodiment, the target recommendation upper bound 444 and the target recommendation lower bound 446 may be determined by the manufacture of the automobile. In addition, the target recommendation upper bound 444 and the target recommendation lower bound 446 may be modified using past recommendations 254 for each inspection item 232.

In one embodiment, the target recommendation upper bound 444 and the target recommendation lower bound 446 include the guard band. In one embodiment, the guard band GB is calculated using Equation 3, where NA is a number of automobiles inspected such as by a technician or at a service location, and L is a nonzero constant. The target recommendation upper bound 444 may be increased by the guard band and the target recommendation lower bound 446 may be decreased by the guard band.

GB=(L/√NA) Equation 3

The recording module 355 may further adjust 558 the target recommendation 236, the target recommendation lower bound 446, and/or the target recommendation upper bound 444 in response to the auto make 202 and/or the auto model 204. For example, the target recommendation 236, the target recommendation lower bound 446, and/or the target recommendation upper bound 444 for an auto make 202 and/or an auto model 204 that typically require service more frequently or less frequently than the manufacturer's recommendations may be adjusted to reflect observed service needs.

The recording module 355 may also adjust 560 the target recommendation 236, the target recommendation lower bound 446, and/or the target recommendation upper bound 444 in response to the auto mileage 212. For example, the target recommendation 236, the target recommendation lower bound 446, and/or the target recommendation upper bound 444 may be increased in response to high auto mileage 212 and decreased in response to low auto mileage 212.

In one embodiment, the recording module 355 adjusts 562 the target recommendation 236, the target recommendation lower bound 446, and/or the target recommendation upper bound 444 in response to the auto year 210. For example, the target recommendation 236, the target recommendation lower bound 446, and/or the target recommendation upper bound 444 may be increased in response to an early model year 210 and decreased in response to a late model year 210.

The recording module 355 may adjust 564 the target recommendation 236, the target recommendation lower bound 446, and/or the target recommendation upper bound 444 in response to recent service 229. For example, the target recommendation 236, the target recommendation lower bound 446, and/or the target recommendation upper bound 444 may be increased in response to earlier recent service 229 and decreased in response to later recent service 229.

The identification module 360 identifies 566 the recommendation bias and the method 550 ends. The identification module 360 may identify 566 the inspection bias in response to a function of first inspection item recommendations 216 for a first inspection item 232 of the plurality of inspection results 205 exceeding a first target recommendation 236 for the first inspection item 232. The function of the inspection item recommendations 216 may be an average of inspection item recommendations 216. In one embodiment, the function of the inspection item recommendations 216 is selected from the group consisting of an arithmetic mean, a geometric mean, a harmonic mean, a quadratic mean, a generalized mean, a weighted mean, a truncated mean, an interquartile mean, a midrange, a Winsorized mean, a mode, and a median of the inspection item recommendations 216. For example, the function of the inspection item recommendations 216 may be the median of all inspection item recommendations 216 for an inspection item 232.

The function of the inspection item recommendations 216 may be calculated for one or more technicians, one or more service locations, one or more regions, and/or one or more operators. The recommendation bias may be identified 566 for a set selected from the group consisting of technicians, service locations, regions, and operators. For example, the function of the inspection item recommendations 216 may be calculated as an arithmetic mean of the service recommendations of each inspection item recommendation 216 for a specified inspection item 232 in a region 220.

In one embodiment, the recommendation bias is identified 566 if the function of the inspection item recommendations 216 exceeds at least one of the target recommendation upper bound 444 and the target recommendation lower bound 446. For example, if the target recommendation upper bound 444 is 40 percent and the mean of the inspection item recommendations 216 is 44 percent, the recommendation bias is identified 566.

FIG. 5C is a schematic flow chart diagram illustrating one embodiment of an assignment bias identification method 600. In addition, the method 600 may identify assignment bias and/or sales bias. The method 600 may be performed by a processor 305. In one embodiment, the method 600 is performed by program code stored on a computer readable storage medium such as the memory 310 and executed by a processor 305 to perform the functions of the method 600.

The method 600 starts, and in one embodiment, the recording module 355 determines 602 a target assignment distribution from the target assignment 240 of an inspection item 232. The target assignment distribution may be assigned by the administrator. Alternatively, the target assignment distribution may be calculated from the target assignment 240 based on the experience and training of each technician at a service location. In one embodiment, each technician with the necessary training and experience may be assigned an equal percentage of the target assignment distribution.

In one embodiment, the target assignment distribution includes an assignment guard band. The assignment guard band may be a specified real number of standard deviations from the target assignment distribution.

The identification module 360 may further identify 604 a function of technician assignments 284 exceeding the target assignment distribution as assignment bias and the method 600 ends. Assignment bias may be identified if the function of the technician assignments 284 exceeds the target assignment distribution. In one embodiment, the function of the technician assignments 284 that exceeds the assignment guard band of the target assignment distribution is identified as assignment bias.

The function of technician assignments may be selected from the group consisting of an arithmetic mean, a geometric mean, a harmonic mean, a quadratic mean, a generalized mean, a weighted mean, a truncated mean, an interquartile mean, a midrange, a Winsorized mean, a mode, and a median. The technician assignments may be retrieved from the recommendation sale 224 of the inspection results 205.

FIG. 5D is a schematic flow chart diagram illustrating one embodiment of a sales bias identification method 650. The method 650 may identify inspection bias. In addition, the method 650 may identify assignment bias and/or sales bias. The method 600 may be performed by a processor 305. In one embodiment, the method 650 is performed by program code stored on a computer readable storage medium such as the memory 310 and executed by a processor 305 to perform the functions of the method 650.

The method 650 starts, and in one embodiment, the recording module 355 determines 652 a sales target 282 for an inspection item 232. In one embodiment, the recording module 355 determines 552 the sales target 282 from stored data. For example, the sales target 282 may be calculated from all past recommendations 254 and recommendations sales 224 for each inspection item 232 of the plurality of inspection results 205. For example, recommendation sales 224 may be divided by service recommendations 415 to generate the sales target 282. In one embodiment, the sales targets 282 are calculated based on the region 220, service location 208, auto make 202, auto model 204, auto year 210, auto mileage 212, and/or recent service 229. For example, the sales target 282 for an air filter replacement may be based on the auto mileage 212 and the recent service 229.

The identification module 360 may compare 654 a ratio of service recommendations 415 and recommendation sales 224 to the sales target 282. The identification module 360 may identify 656 the ratio of service recommendations 415 to recommendation sales 224 that is less than a sales target 282 as sales bias and the method 650 ends.

The embodiments record inspection results 205 and identify a recommendation bias using inspection results 205. In addition, the embodiments may identify assignment bias and sales bias. By identifying biases resulting from automobile inspections, the embodiments support the management of service locations in improving the performance of technicians through training and supervision.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for analyzing automotive inspections comprising:
recording, by use of a processor, a plurality of inspection results, wherein each inspection result comprises a technician identifier and an inspection item recommendation for each of a plurality of inspection items, each inspection item comprises a target recommendation, and the inspection item recommendation comprises one of a no service required recommendation and a service recommendation; and
identifying a recommendation bias in response to a function of first inspection item recommendations for a first inspection item of the plurality of inspection results exceeding a first target recommendation for the first inspection item.

2. The method of claim 1, wherein the target recommendation comprises a target recommendation upper bound and a target recommendation lower bound and the recommendation bias is identified for the function of the first inspection item recommendations exceeding at least one of the target recommendation upper bound and the target recommendation lower bound.

3. The method of claim 2, wherein the target recommendation upper bound and the target recommendation lower bound comprise a guard band.

4. The method of claim 1, wherein each inspection result further comprises an auto year and an auto mileage and the target recommendations are a function of the auto year and the auto mileage.

5. The method of claim 1, wherein the target recommendations are modified by an auto year and an auto mileage.

6. The method of claim 1, wherein the target recommendations are set by an administrator.

7. The method of claim 1, wherein the target recommendations are a function of the inspection item recommendations.

8. The method of claim 7, wherein the target recommendations are a function of the inspection item recommendations for one or more technicians and one or more of service locations.

9. The method of claim 1, wherein each inspection result further comprises a region and the target recommendations are a function of inspection item recommendations for a specified region.

10. The method of claim 1, the method further comprising:
determining a target assignment distribution; and
identifying an assignment bias in response to a function of technician assignments for the first inspection item exceeding a first target assignment for the first inspection item.

11. The method of claim 10, wherein the first target assignment is set by an administrator.

12. The method of claim 1, wherein each inspection result further comprises a recommendation sale that indicates a sale of the service recommendation.

13. The method of claim 12, the method further comprising:
comparing the service recommendations to the recommendation sales; and
identifying a sales bias in response to a ratio of service recommendations to recommendation sales being less than a sales target.

14. The method of claim 13, further comprising generating a report comprising the sales bias.

15. The method of claim 1, wherein the plurality of inspection results are recorded from a portable computer.

16. The method of claim 1, further comprising retrieving auto information comprising a customer name, a customer address, a license number, a vehicle identification number, the auto year, an auto make, an auto model, recent service, and reporting data.

17. The method of claim 1, further comprising generating a report comprising the identification bias.

18. The method of claim 1, wherein the recommendation bias is identified for a set selected from the group consisting of technicians, locations, regions, and operators.

19. An apparatus comprising:
a non-tangible computer readable storage medium storing program code that is executable by a processor, the program code comprising:
a recording module that records a plurality of inspection results, wherein each inspection result comprises a technician identifier and an inspection item recommendation for each of a plurality of inspection items, each inspection item comprises a target recommendation, and the inspection item recommendation comprises one of a no service required recommendation and a service recommendation; and
an identification module that identifies a recommendation bias in response to a function of first inspection item recommendations for a first inspection item of the plurality of inspection results exceeding a first target recommendation for the first inspection item.

20. A program product comprising a non-tangible computer readable storage medium storing program code executable by a processor, the program code:
recording a plurality of inspection results, wherein each inspection result comprises a technician identifier and an inspection item recommendation for each of a plurality of inspection items, each inspection item comprises a target recommendation, and the inspection item recommendation comprises one of a no service required recommendation and a service recommendation; and
identifying a recommendation bias in response to a function of first inspection item recommendations for a first inspection item of the plurality of inspection results exceeding a first target recommendation for the first inspection item.
